(19) United States
(12) Patent Application Publication
(10) Pub. No.: US 2023/0215136 A1
(43) Pub. Date: Jul. 6, 2023

(54) METHOD FOR TRAINING MULTI-MODAL DATA MATCHING DEGREE CALCULATION MODEL, METHOD FOR CALCULATING MULTI-MODAL DATA MATCHING DEGREE, AND RELATED APPARATUSES

(71) Applicant: Beijing Baidu Netcom Science Technology Co., Ltd., Beijing (CN)

(72) Inventors: Haoran WANG, Beijing (CN); Dongliang HE, Beijing (CN); Fu LI, Beijing (CN); Errui DING, Beijing (CN)

(21) Appl. No.: 18/113,826

(22) Filed: Feb. 24, 2023

(30) Foreign Application Priority Data
Apr. 29, 2022 (CN) 202210493960.0

(51) Int. Cl. G06V 10/74; G06V 10/77

(52) U.S. Cl. CPC G06V 10/761; G06V 10/7715

(57) ABSTRACT

The present disclosure provides a method and apparatus for training a multi-modal data matching degree calculation model, a method and apparatus for calculating a multi-modal data matching degree, an electronic device, a computer readable storage medium and a computer program product, and relates to the field of artificial intelligence technology such as deep learning, image processing and computer vision. The method comprises: acquiring first sample data and second sample data that are different in modalities; constructing a contrastive learning loss function comprising a semantic perplexity parameter, the semantic perplexity parameter being determined based on a semantic feature distance between the first sample data and the second sample data; and training, by using the contrastive learning loss function, an initial multi-modal data matching degree calculation model through a contrastive learning approach, to obtain a target multi-modal data matching degree calculation model.

### CROSS-REFERENCE TO RELATED APPLICATIONS

This application claims priority to Chinese Patent Application No. 202210493960.0, filed with the China National Intellectual Property Administration (CNIPA) on Apr. 29, 2022, the content of which is incorporated herein by reference in its entirety.

### TECHNICAL FIELD

The present disclosure relates to the field of artificial intelligence technology such as deep learning, image processing and computer vision, and particularly to a method for training a multi-modal data matching degree calculation model, a method for calculating a multi-modal data matching degree, corresponding apparatuses, an electronic device, a computer readable storage medium and a computer program product.

### BACKGROUND

The purpose of matching across modalities is to establish a semantic association between data of different modalities. Here, data of a certain modality is used as a query item, and matching is performed on another modality of data having a semantic meaning same as or similar to that of the data of the certain modality. Here, for an image and a text (the two types of information most widely existing in Internet), a cross-modal retrieval therebetween (i.e., image-text matching) is also generally considered to be the core task of cross-modal retrievals.

### SUMMARY

Embodiments of the present disclosure propose a method and apparatus for training a multi-modal data matching degree calculation model, a method and apparatus for calculating a multi-modal data matching degree, an electronic device, a computer readable storage medium and a computer program product.

In a first aspect, some embodiments of the present disclosure provide a method for training a multi-modal data matching degree calculation model, comprising: acquiring first sample data and second sample data that are different in modalities; constructing a contrastive learning loss function comprising a semantic perplexity parameter, the semantic perplexity parameter being determined based on a semantic feature distance between the first sample data and the second sample data; and training, by using the contrastive learning loss function, an initial multi-modal data matching degree calculation model through a contrastive learning approach, to obtain a target multi-modal data matching degree calculation model.

In a second aspect, some embodiments of the present disclosure provide an apparatus for training a multi-modal data matching degree calculation model, the apparatus includes: a sample data acquiring unit, configured to acquire first sample data and second sample data that are different in modalities; a loss function constructing unit, configured to construct a contrastive learning loss function comprising a semantic perplexity parameter, the semantic perplexity parameter being determined based on a semantic feature distance between the first sample data and the second sample data; and a multi-modal data matching degree calculation model training unit, configured to train, by using the contrastive learning loss function, an initial multi-modal data matching degree calculation model through a contrastive learning approach, to obtain a target multi-modal data matching degree calculation model.

In a third aspect, some embodiments of the present disclosure provide a method for calculating a multi-modal data matching degree. The method includes: acquiring a to-be-tested data pair composed of first data and second data that are different in modalities; invoking a preset multi-modal data matching degree calculation model to process the to-be-tested data pair, to obtain a semantic matching degree of the to-be-tested data pair; wherein the multi-modal data matching degree calculation model is trained and obtained based on a contrastive learning loss function through a contrastive learning approach, the contrastive learning loss function comprises a semantic perplexity parameter, and the semantic perplexity parameter is determined based on a semantic feature distance between first sample data and second sample data that are different in modalities.

In a fourth aspect, some embodiments of the present disclosure provide an apparatus for calculating a multi-modal data matching degree. The apparatus includes: a to-be-matched data acquiring unit, configured to acquire a to-be-tested data pair composed of first data and second data that are different in modalities; a matching degree calculating unit, configured to invoke a preset multi-modal data matching degree calculation model to process the to-be-tested data pair, to obtain a semantic matching degree of the to-be-tested data pair; wherein the multi-modal data matching degree calculation model is trained and obtained based on a contrastive learning loss function through a contrastive learning approach, the contrastive learning loss function comprises a semantic perplexity parameter, and the semantic perplexity parameter is determined based on a semantic feature distance between first sample data and second sample data that are different in modalities.

In a fifth aspect, some embodiments of the present disclosure provide an electronic device. The electronic device includes: at least one processor; and a storage device, in communication with the at least one processor, where the storage device stores instructions executable by the at least one processor, and the instructions are executed by the at least one processor, to enable the at least one processor to perform the method for training a multi-modal data matching degree calculation model according to any one of the implementations described in the first aspect and/or the method for calculating a multi-modal data matching degree according to any one of the implementations described in the third aspect.

In a sixth aspect, some embodiments of the present disclosure provide a non-transitory computer readable storage medium, storing a computer instruction, where the computer instruction is used to cause the computer to perform the method for training a multi-modal data matching degree calculation model according to any one of the implementations described in the first aspect and/or the method for calculating a multi-modal data matching degree according to the implementations described in the first aspect.

It should be understood that the content described in this part is not intended to identify key or important features of embodiments of the present disclosure, and is not used to limit the scope of the present disclosure. Other features of the present disclosure will be easily understood through the following description.

### BRIEF DESCRIPTION OF THE DRAWINGS

Through detailed descriptions of non-limiting embodiments given with reference to the following accompanying drawings, other features, objectives and advantages of the present disclosure will be more apparent:

FIG. 1 illustrates an example system architecture in which embodiments of the present disclosure may be applied;

FIG. 2 is a flowchart of a method for training a multi-modal data matching degree calculation model provided by an embodiment of the present disclosure;

FIG. 3 is a flowchart of a method for extracting a semantic feature based on a memory bank provided by an embodiment of the present disclosure;

FIG. 4 is a schematic diagram of a network structure of a multi-modal data matching degree calculation model obtained based on the method for training a multi-modal data matching degree calculation model in an application scenario, provided by an embodiment of the present disclosure;

FIG. 5 is a structural block diagram of an apparatus for training a multi-modal data matching degree calculation model provided by an embodiment of the present disclosure;

FIG. 6 is a structural block diagram of an apparatus for calculating a multi-modal data matching degree provided by an embodiment of the present disclosure; and

FIG. 7 is a schematic structural diagram of an electronic device adapted to perform the method for training a multi-modal data matching degree calculation model and/or a method for calculating a multi-modal data matching degree, provided by an embodiment of the present disclosure.

### DETAILED DESCRIPTION

Example embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description. It should be noted that embodiments in the present disclosure and the features in the embodiments may be combined with each other on a non-conflict basis.

In the technical solution of the present disclosure, the acquisition, storage, application, etc. of the personal information of a user (e.g., identity information and face image related to the user that are included in first sample data and second sample data) all comply with the provisions of the relevant laws and regulations, necessary confidentiality measures are taken, and public order and good customs are not violated.

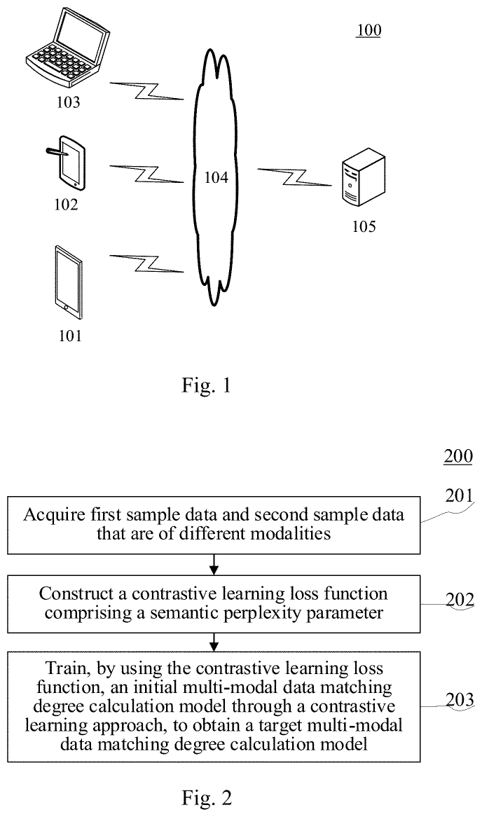

FIG. 1 illustrates an example system architecture 100 in which embodiments of a method and apparatus for training a face recognition model, a method and apparatus for recognizing a face, an electronic device and a computer-readable storage medium according to embodiments of the present disclosure may be applied.

As shown in FIG. 1, the system architecture 100 may include terminal device(s) 101, 102, 103, a network 104 and a server 105. The network 104 serves as a medium providing a communication link between the terminal device(s) 101, 102, 103 and the server 105. The network 104 may include various types of connections, for example, wired or wireless communication links, or optical fiber cables.

A user may use the terminal device(s) 101, 102, 103 to interact with the server 105 via the network 104, to receive or send a message, etc. On the terminal device(s) 101, 102, 103 and the server 105, various applications (e.g., a cross-modal matching application and a cross-modal data matching degree calculation application) for implementing information communication therebetween may be installed.

The terminal device(s) 101, 102, 103 and the server 105 may be hardware or software. When being the hardware, the terminal device(s) 101, 102, 103 may be various electronic devices having a display screen, the electronic devices including, but not limited to, a smartphone, a tablet computer, a laptop portable computer, a desktop computer, and the like. When being the software, the terminal device(s) 101, 102, 103 may be installed in the above electronic devices. The terminal devices may be implemented as a plurality of pieces of software or a plurality of software modules, or may be implemented as a single piece of software or a single software module, which will not be specifically limited here. When being the hardware, the server 105 may be implemented as a distributed server cluster composed of a plurality of servers, or may be implemented as a single server. When being the software, the server 105 may be implemented as a plurality of pieces of software or a plurality of software modules, or may be implemented as a single piece of software or a single software module, which will not be specifically limited here.

The server 105 can provide various services through various built-in applications. A cross-modal data matching degree calculation application that can provide an image-text matching degree calculation service for the user is taken as an example. When running the image-text matching application, the server 105 can achieve the following effects: a to-be-tested data pair composed of first data embodied as image data and second data embodied as text data is acquired; a preset multi-modal data matching degree calculation model is invoked to process the to-be-tested data pair, to obtain a semantic matching degree of the to-be-tested data pair. Here, based on a contrastive learning loss function, the multi-modal data matching degree calculation model is trained and obtained through a contrastive learning approach. The contrastive learning loss function comprises a semantic perplexity parameter, and the semantic perplexity parameter is determined based on a semantic feature distance between first sample data and second sample data that are different in modalities.

Here, the multi-modal data matching degree calculation model can be trained and obtained by a multi-modal data matching degree calculation model training application built in the server 105 according to the following steps: acquiring the first sample data and the second sample data that are different in modalities; constructing the contrastive learning loss function comprising the semantic perplexity parameter, the semantic perplexity parameter being determined based on the semantic feature distance between the first sample data and the second sample data; and training, by using the contrastive learning loss function, an initial multi-modal data matching degree calculation model through a contrastive learning approach, to obtain a target multi-modal data matching degree calculation model.

Since the training to obtain the multi-modal data matching degree calculation model occupies many computing resources and needs a strong computing capability, the method for training a multi-modal data matching degree calculation model provided in subsequent embodiments of the present disclosure is generally performed by the server 105 having a strong computing capability and many computing resources. Correspondingly, the apparatus for training a multi-modal data matching degree calculation model is generally provided in the server 105. However, it should also be noted that, when having a computing capability and computing resources that satisfy requirements, the terminal device(s) 101, 102, 103 may also complete, through the multi-modal data matching degree calculation model training application installed thereon, the computations originally performed by the server 105, to output the same result as that of the server 105. Correspondingly, the apparatus for training a multi-modal data matching degree calculation model may alternatively be provided in the terminal device(s) 101, 102, 103. In this situation, the example system architecture 100 may alternatively not include the server 105 and the network 104.

Clearly, the server used to train and obtain the multi-modal data matching degree calculation model may be different from the server invoking a trained multi-modal data matching degree calculation model for use. In particular, for the multi-modal data matching degree calculation model trained by the server 105, a lightweight multi-modal data matching degree calculation model suitable for being built in the terminal device(s) 101, 102, 103 may alternatively be obtained through a model distillation approach. That is, according to the actually required recognition accuracy, it is possible to flexibly select the lightweight multi-modal data matching degree calculation model in the terminal device(s) 101, 102, 103 or the complicated multi-modal data matching degree calculation model in the server 105 for use.

It should be appreciated that the numbers of the terminal devices, the networks and the servers in FIG. 1 are merely illustrative. Any number of terminal devices, networks and servers may be provided based on actual requirements.

According to the method for training a multi-modal data matching degree calculation model and the method for calculating a multi-modal data matching degree that are provided in embodiments of the present disclosure, the first sample data and the second sample data that are different in modalities are acquired. Then, the contrastive learning loss function comprising the semantic perplexity parameter is constructed, and the contrastive learning loss function is used to train the initial multi-modal data matching degree calculation model through the contrastive learning approach. The semantic perplexity parameter is determined based on the semantic feature distance between the first sample data and the second sample data. Finally, the initial multi-modal data matching degree calculation model is trained using the first sample data, the second sample data and the contrastive learning loss function, to obtain the target multi-modal data matching degree calculation model.

According to the method for training a multi-modal data matching degree calculation model and the method for calculating a multi-modal data matching degree that are provided in embodiments of the present disclosure, the semantic perplexity parameter is added to the loss function constructed based on a conventional contrastive learning idea. The semantic perplexity parameter is determined and obtained based on the semantic feature distance between the first sample data and the second sample data that are different in modalities, such that the constructed contrastive learning loss function comprising the semantic perplexity parameter is capable of adjusting the attention to the cross-modal matching on the samples according to the size of the semantic perplexity in the model training stage. Accordingly, when the multi-modal data matching degree calculation model is used subsequently, the matching precision can be improved by increasing the degree of attention to the input data including candidate data having a high semantic perplexity.

Referring to FIG. 2, FIG. 2 is a flowchart of a method for training a multi-modal data matching degree calculation model provided by an embodiment of the present disclosure. Here, the flow 200 includes the following steps:

Step 201, acquiring first sample data and second sample data that are different in modalities.

In this embodiment, an executing body (e.g., the server shown in FIG. 1) of the method for training a multi-modal data matching degree calculation model may acquire the first sample data and the second sample data. Here, the first sample data and the second sample data are different in modalities. As an example, the first sample data is image data, and the second sample data is text data. As another example, the first sample data is video data, and the second sample data is text data.

It should be noted that the first sample data and the second sample data may be directly acquired by the above executing body from a local storage device or from a non-local storage device (e.g., the terminal device(s) 101, 102, 103 shown in FIG. 1). The local storage device may be a data storage module (e.g., a server hard disk) provided within the above executing body. In such a case, two original pictures and their sorting information may be quickly read locally. The non-local storage device may alternatively be any other electronic device provided to store data, for example, some user terminals. In such a case, the above executing body may send an acquisition command to the electronic device to acquire the required first sample data and second sample data therefrom.

Step 202, constructing a contrastive learning loss function comprising a semantic perplexity parameter.

In this embodiment, after the first sample data and the second sample data are acquired, a semantic feature of the first sample data and a semantic feature of an output sample are respectively acquired, and a semantic perplexity parameter for representing a semantic feature distance between the first sample data and the second sample data is established. Then, the contrastive learning loss function, which comprises the semantic perplexity parameter and is used to train an initial multi-modal data matching degree calculation model through a contrastive learning approach, is constructed based on the semantic perplexity parameter.

Here, contrastive learning is essentially a self-supervised learning method, which is used to learn the general feature of a data set by making a model to learn, without labels, the particular similarity or difference between data. In embodiments of the present disclosure, the main purpose is to find the similarity or difference in semantic meanings between data of different modalities through this characteristic of the contrastive learning.

Here, the semantic perplexity parameter may be determined based on a calculation approach such as a Euclidean distance, a Manhattan distance, and a Mahalanobis distance, which is used to calculate a feature distance between the semantic feature corresponding to the first sample data and the semantic feature corresponding to the second sample data. In some embodiments, a plurality of numerical value intervals may be set in advance, so as to determine the semantic perplexity parameter according to a numerical value interval in which the numerical value of the generated feature distance falls.

Step 203, training, by using the contrastive learning loss function, an initial multi-modal data matching degree calculation model through a contrastive learning approach, to obtain a target multi-modal data matching degree calculation model.

In this embodiment, after the contrastive learning loss function comprising the semantic perplexity parameter is constructed in step 202, an initial multi-modal data matching degree calculation model is trained using the first sample data, the second sample data and the contrastive learning loss function comprising the semantic perplexity parameter, thus obtaining the target multi-modal data matching degree calculation model.

According to the method for training a multi-modal data matching degree calculation model provided by embodiments of the present disclosure, the semantic perplexity parameter, which is determined based on the semantic feature distance between the first sample data and the second sample data that are different in modalities, is added to the loss function constructed based on a conventional contrastive learning idea. The multi-modal data matching degree calculation model, which is trained through the contrastive learning loss function, is capable of adjusting the degree of attention to the calculation of the matching degree between data of different modalities according to the semantic perplexity of a multi-modal data pair that is used to calculate a matching degree, to acquire the matching degree between data of a plurality of modalities more accurately.

In some alternative implementations of this embodiment, constructing, based on a semantic perplexity, the contrastive learning loss function used to train the initial multi-modal data matching degree calculation model through the contrastive learning approach includes: acquiring an initial contrastive learning loss function in the contrastive learning approach, the initial contrastive learning loss function being used to supervise model training; representing the semantic perplexity parameter with a cosine relationship between a semantic feature of the first sample data and a semantic feature of the second sample data; and constructing the contrastive learning loss function based on the initial contrastive learning loss function and the semantic perplexity parameter.

Particularly, after the semantic feature of the first sample data and the semantic feature of the second sample data are respectively acquired, the cosine relationship between the semantic feature of the first sample data and the semantic feature of the second sample data, which may be used to represent the semantic feature distance between the semantic feature of the sample data and the semantic feature of the second sample data, may be used to the represent the semantic perplexity parameter. The contrastive learning loss function may be constructed based on the initial contrastive learning loss function and the semantic perplexity parameter, so as to quickly and easily represent the semantic feature distance between the semantic feature of the first sample data and the semantic feature of the second sample data corresponding to the first sample data, thereby improving the efficiency of marking the semantic perplexity.

In some alternative embodiments, when a first sample data set including a plurality of pieces of first sample data and a second sample data set including a plurality of pieces of second sample data are used as samples to train the initial multi-modal data matching degree calculation model, that is, when the first sample data and/or the second sample data are embodied in the form of data sets, the semantic feature distance between the first sample data (the first sample data set) and each piece of second sample data included in the second sample data set may be determined based on the above approach. Moreover, the semantic perplexity between the first sample data as input data and the second sample data set may be obtained by statistics. At this point, the semantic perplexity may be determined based on the following mathematical expressions:

$$SD ( i ) = \sqrt{E ( {S}_{ij} ) - {[ E ( {S}_{ij} ) ]}^{2}} , i \neq j \qquad ( 1 )$$

$$per ( i ) = σ ( \frac{ε}{SD ( i )} ) \qquad ( 2 )$$

Here, E ( ) denotes a mathematical expectation, σ( ) denotes an activation (Sigmoid) function for normalizing the reciprocal of an SD value, and per(i) denotes a semantic perplexity of first sample data i with respect to a second sample data set; ε represents a hyperparameter for adjusting the smoothness of a function, and Sᵢⱼ denotes a feature distance between the first sample data i and second sample data j.

Further, an initial contrastive learning loss function L_{PCL_I}(V,T) used to train a model through a contrastive learning approach is acquired as follows:

$${l}_{PCL \_ I} ( V , T ) = \frac{μ}{N} {\sum }_{n = 1}^{N} [ log ( {\sum }_{q \neq n} exp ( \frac{( {S}_{nq} - γ )}{μ} ) + 1 ) - log ( {S}_{nn} + 1 ) ] \qquad ( 3 )$$

$${l}_{PCL \_ I} ( T , V ) = \frac{μ}{Q} {\sum }_{n = 1}^{Q} [ log ( {\sum }_{n \neq q} exp ( \frac{( {S}_{qn} - γ )}{μ} ) + 1 ) - log ( {S}_{qq} + 1 ) ] \qquad ( 4 )$$

$${L}_{PCL \_ I} ( T , V ) = {l}_{PCL \_ I} ( T , V ) + {l}_{PCL \_ I} ( V , T ) \qquad ( 5 )$$

Here, V denotes first sample data, T denotes second sample data, μ is a temperature parameter, γ is a boundary parameter, N and Q are numbers of samples in a mini-batch, and S_{nq}=cos(Vₙ,T_{q}), S_{qn}=cos (T_{q},Vₙ), Sₙₙ=cos(Vₙ,Tₙ) and S_{qq}=cosine(T_{q},V_{q}) each denotes a cosine similarity.

Then, the semantic perplexity obtained based on the above formula (2) is introduced into L_{PCL_I}(T,V) obtained based on the above formula (5), to generate a contrastive learning loss function L_{PCL}(T,V) which is constructed based on the semantic perplexity and is used to train the initial multi-modal data matching degree calculation model through a contrastive learning approach, which is specifically as follows:

$${l}_{PCL} ( T , V ) = \frac{μ}{N} {\sum }_{n = 1}^{N} [ log ( {\sum }_{q \neq n} exp ( \frac{( {S}_{qn} - γ ) per ( n )}{μ} ) + 1 ) - log ( {S}_{nn} + 1 ) ] \qquad ( 3 )$$

$${l}_{PCL} ( T , V ) = \frac{μ}{Q} {\sum }_{q = 1}^{Q} [ log ( {\sum }_{n \neq q} exp ( \frac{( {S}_{qn} - γ ) per ( q )}{μ} ) + 1 ) - log ( {S}_{qq} + 1 ) ] \qquad ( 7 )$$

$${L}_{PCL} ( T , V ) = {l}_{PCL \_ I} ( T , V ) + {l}_{PCL \_ I} ( V , T ) \qquad ( 8 )$$

Here, per(n) and per(q) denote the semantic perplexity of Vₙ and the semantic perplexity of T_{q}, which are respectively used to adaptively assign a weight to each negative sample, and the other involved parameters correspond to those in the above formulas (3)-(5), which will not be repeatedly described here.

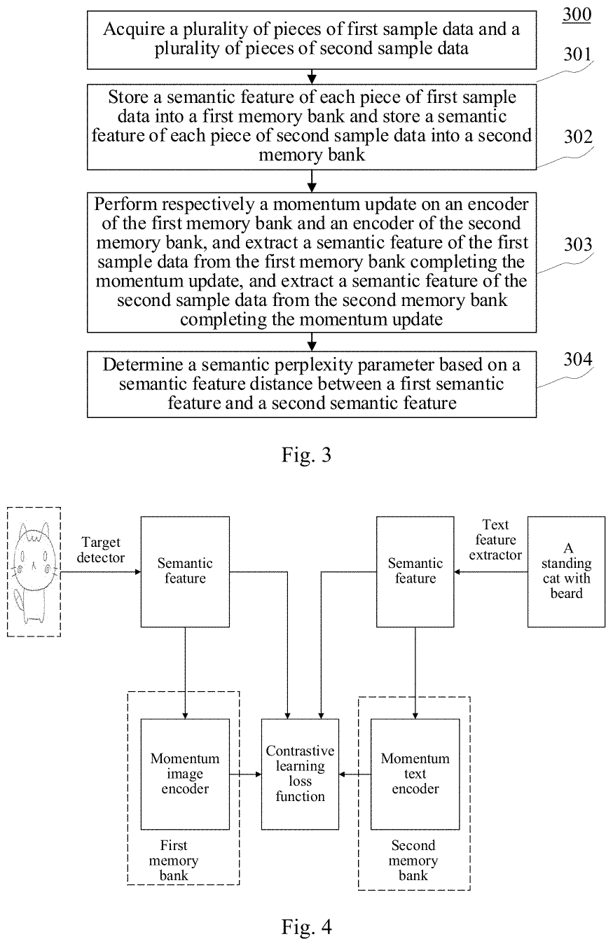

Referring to FIG. 3, FIG. 3 is a flowchart of an acquisition of a semantic feature of first sample data and a semantic feature of second sample data provided by an embodiment of the present disclosure. That is, a detailed acquisition approach is provided for the semantic features involved in step 202 of the embodiment shown in FIG. 2. Here, the flow 300 includes the following steps:

Step 301, acquiring a plurality of pieces of first sample data and a plurality of pieces of second sample data.

In this embodiment, the plurality of pieces of first sample data and the plurality of pieces of second sample data are acquired in a scenario where a multi-modal data matching degree calculation model is trained using a plurality of pieces of different first sample data and a plurality of pieces of different second sample data.

Step 302, storing a semantic feature of each piece of first sample data into a first memory bank and storing a semantic feature of each piece of second sample data into a second memory bank.

In this embodiment, a feature extractor is respectively used to extract the semantic feature corresponding to each piece of first sample data and the semantic feature corresponding to each piece of second sample data, the semantic feature of the first sample data is stored into the first memory bank, and the semantic feature of the second sample data is stored into the second memory bank. For example, when the first sample data is image data and the second sample data is text data, a target detector may be adopted to extract a semantic feature from the first sample data, and a text feature extractor may be adopted to extract a semantic feature from the second sample data.

Here, a memory bank is a sample storage device used in contrastive learning. Taking sample data in the form of an image as an example, the semantic feature corresponding to sample image data can be stored, such that the memory bank is used to perform a quick extraction based on the semantic feature corresponding to the sample image data.

Here, in the training iteration process, a mini-batch of first sample data, a mini-batch of second sample data and their respective semantic features are continuously stored into the memory banks by adopting a queue first in first out approach.

In practice, after the extraction for the semantic feature of the first sample data and the semantic feature of the second sample data is completed, a first global feature of the first sample data and a second global feature of the second sample data may further be generated through a Global average pooling (GAP, used to minimize an overfitting effect by reducing the number of parameters in a model) operation, to improve the quality of the semantic features stored into the first memory bank and the second memory bank.

Step 303, performing respectively momentum update on an encoder of the first memory bank and an encoder of the second memory bank, and extracting a semantic feature of the first sample data from the first memory bank completing the momentum update, and extracting a semantic feature of the second sample data from the second memory bank completing the momentum update.

Here, the momentum update is a model parameter updating technique different from a gradient based back-propagation optimization algorithm. When the momentum update is applied, the parameter of an updated Key encoder follows the parameter of a Query encoder optimized based on gradient back-propagation and changes slowly, which may avoid a large amount of computation and storage overhead requirements caused during the gradient back-propagation optimization while making the Key encoder keep good consistency with the semantic feature outputted by the Query encoder. Subsequently, it may extract the semantic feature B_{V}^{I} of the first sample data from the first memory bank which completes the momentum update, and the semantic feature B_{T}^{I} of the second sample data from the second memory bank which completes the momentum update.

In this embodiment, g_{V}( ) and g_{T}( ) are respectively used as a reference encoder to perform a parameter update on the encoder g_{V}^{B}( ) of the first memory bank and the encoder g_{T}^{B}( ) of the second memory bank. Here, the reference encoders g_{V}( ) and g_{T}( ) may be referred to as Key encoders, and the encoders g_{V}^{B}( ) and g_{T}^{B}( ) which is to be updated may be referred to as Query encoders. θₖ^{V}(θₖ^{T}) is used to express a model parameter of the Query encoder g_{V}^{B}( ) (g_{T}^{B}( )), and θ_{q}^{V}(θ_{q}^{T}) is used to express a model parameter of the Key encoder g_{V}( ) (g_{T}( )). The mathematical form of the momentum update process may be expressed as:

θ_{K}^{V}=mθ_{K}^{V}+(1−m)θ_{Q}^{V} (9)

θ_{K}^{T}=mθ_{K}^{T}+(1−m)θ_{Q}^{T} (10)

Here, m=0.995, referred to as a momentum update coefficient.

Step 304, determining a semantic perplexity parameter based on a semantic feature distance between a first semantic feature and a second semantic feature.

In this embodiment, the way in which the semantic perplexity parameter is determined based on the semantic feature distance between the first semantic feature and the second semantic feature is the same as that in the embodiment shown in FIG. 2 and in some of the following alternative embodiments, and thus will not be repeatedly described here.

In this embodiment, on the basis of the above embodiment shown in FIG. 2, the each piece of first sample data and the each piece of second sample data are further processed using the memory banks, so as to avoid that the performance of the model is restricted due to the small batch size of the sample data including the first sample data and the second sample data during the training for the initial multi-modal data matching degree calculation model, to further improve the performance of the multi-modal data matching degree calculation model obtained through the training.

In some alternative implementations of this embodiment, the storing a semantic feature of each piece of first sample data into a first memory bank and storing a semantic feature of each piece of second sample data into a second memory bank includes: storing at least two pieces of first sample data into the first memory bank in a form of a set, and storing at least two pieces of second sample data into the second memory bank in a form of a set.

Particularly, in the process of storing the semantic feature of the first sample data into the first memory bank and the semantic feature of the second sample data into the second memory bank, a plurality of first sample data sets and the second sample data sets may further be respectively constructed. There are at least two pieces of first sample data in a first sample data set, and there are at least two pieces of second sample data in a second sample data set. Subsequently, the semantic features corresponding to the first sample data and the semantic features of the second sample data are respectively stored into the first memory bank and the second memory bank in the form of a set, so as to improve the efficiency of training the multi-modal data matching degree calculation model through a batch training approach.

In some alternative implementations of this embodiment, the method further includes: imposing a constraint on at least one of the following items in the contrastive learning loss function: the first sample data, the second sample data, a semantic feature of the first sample data that is obtained based on the first memory bank, or a semantic feature of the second sample data that is obtained based on the second memory bank.

Particularly, according to requirements, the constraint may be further imposed on at least one of the first sample data, the second sample data, the semantic feature of the first sample data that is obtained based on the first memory bank, or the semantic feature of the second sample data that is obtained based on the second memory bank, in the determined contrastive learning loss function, to improve the effect of training the initial multi-modal data matching degree calculation model. For example, a constraint is imposed on a Mini-batch data pair (T,V), denoted by L_{PCL}^{batch}(T,V); and a constraint is imposed on the first memory bank and the second memory bank that are paired, denoted by L_{PCL}^{bank}(T,V). At this time, the finally obtained overall contrastive learning loss function may be:

L_{PCL}=L_{PCL}^{batch}(V,T)+L_{PCL}^{bank}(V,B_{T}^{I})+L_{PCL}^{bank}(T,B_{V}^{I}) (11)

The above embodiments illustrate how to train and obtain a multi-modal data matching degree calculation model from various aspects. Moreover, in order to emphasize as much as possible the effect achieved by the trained multi-modal data matching degree calculation model from an actual use scenario, an embodiment of the present disclosure further provides a detailed implementation in which the model is used to implement the calculation for a matching degree between data of a plurality of modalities.

First, a to-be-tested data pair composed of first data and second data that are different in modalities is acquired.

Particularly, the to-be-tested data pair composed of the first data and the second data that are different in modalities is acquired. Here, for example, the first data is embodied as image data, and the second data is embodied as text data.

Further, a preset multi-modal data matching degree calculation model is invoked to process the to-be-tested data pair, to obtain a semantic matching degree of the to-be-tested data pair.

Particularly, after the multi-modal data matching degree calculation model that is trained and obtained by using the contrastive learning loss function constructed based on the semantic perplexity and provided in the above embodiment of FIG. 2 is invoked, the to-be-tested data pair is processed using the multi-modal data matching degree calculation model, to obtain a multi-modal data matching degree between the first data and the second data.

That is, according to the method for calculating a multi-modal data matching degree provided in this embodiment, after the to-be-tested data pair composed of the first data and the second data that are different in modalities is acquired, the multi-modal data matching degree calculation model, which is trained and obtained by using the contrastive learning loss function comprising the semantic perplexity parameter, is invoked to process the to-be-tested data pair, to obtain a matching degree between the first data and the second data that are included in the to-be-tested data pair. The multi-modal data matching degree calculation model may determine, based on the semantic perplexity parameter between the first data and the second data, a corresponding matching degree calculation strategy and matching resource. That is, the matching degree between the first data and the second data is calculated by using the matching degree calculation strategy and the matching resource that match the semantic perplexity parameter, rather than through an approach of uniformly or fixedly allocating a calculation resource in the prior art. Thus, the matching degree calculation resources can be tilted toward the first data and the second data that have a high semantic perplexity, to further improve the accuracy of the calculation for the degree of matching.

To deepen understanding, an embodiment of the present disclosure further provides a detailed implementation in combination with a specific application scenario where a degree of matching between data of two modalities (an image modality and a text modality) is calculated.

Referring to FIG. 4, FIG. 4 is a schematic diagram of a network structure used to implement a calculation for an image-text matching degree. In FIG. 4, for a sample image inputted from the left side, a local image feature (it should be noted that the features described currently and subsequently are all semantic features) of the sample image is extracted through a target detector such as a Faster-RCNN (which is a model improved by combining an RCNN and a Fast RCNN, the RCNN (Region-CNN) being literally translated in Chinese as “local CNN,” the Fast RCNN being literally translated in Chinese as “fast CNN,” and CNN being a convolutional neural network), and a global image feature is obtained through a global average pooling operation. For a sample text inputted from the right side, a local text feature of the sample text is extracted through a text feature extractor such as a BERT (Bidirectional Encoder Representation from Transformer, a pre-trained language representation model), and a global text feature is obtained through a global average pooling operation.

For the problem that the batch size is insufficient, FIG. 4 further introduces a momentum contrastive learning framework. That is, memory banks are respectively established for the data of the two modalities (the image modality and the text modality). Meanwhile, through a Queue first-in-first-out approach, a Mini-batch of data is continuously stored into the memory bank in a training iteration process. At the same time, the target detector (which here may be the FastCNN when the local feature extraction is performed on the sample image using the FastCNN) and the text feature extractor (which here is the BERT when the local feature extraction is performed on the sample text using the BERT) are used as reference models, to perform respectively parameter update on the encoders of the memory banks of the image and the text through a momentum update approach. Finally, a target image feature and a target text feature that are outputted by the memory banks after the momentum update are obtained.

Next, by using the target image feature and the global image feature that are outputted by the memory bank of the image and the target text feature and the global text feature that are outputted by the memory bank of the text, an image-text data matching degree calculation model is trained through a contrastive learning approach, based on a pre-constructed contrastive learning loss function (referring to the above formula 11 and the related prepositive formula from which the formula 11 is derived). Further, it is also possible to perform a global average pooling operation on the target image feature and the target text feature, such that the target image feature and the target text feature are consistent with the global image feature and the global text feature in feature characteristics.

That is, in use, after a pair of image data and text data is inputted, by using an extraction approach in which a semantic feature is extracted based on a contrastive learning loss function during training, the trained image-text data matching degree calculation model first extracts the semantic feature of the image data and the semantic feature of the text data, calculates the distance between the semantic features through a cosine approach, generates an image-text data matching degree based on the calculated distance, and finally uses the image-text data matching degree as the output result of the model for output.

This embodiment provides, through FIG. 4, a specific scheme of training and using a model for calculating an image-text data matching degree. It should be stated that, in addition to the calculation for the “image-text” data matching degree, the scheme provided in embodiments of the present disclosure may also be applied to the combination of many different modalities of data such as “image-voice” and “text-voice.” To provide a model calculating degrees of matching between data of different modalities, it only needs to input two modalities of sample data matching the target use into the model training result, and use the feature extractors corresponding to the modalities. Accordingly, similar to the target detector extracting the local feature of image data, a similar CNN or DNN may be used as a feature extractor when the local feature of voice data is extracted.

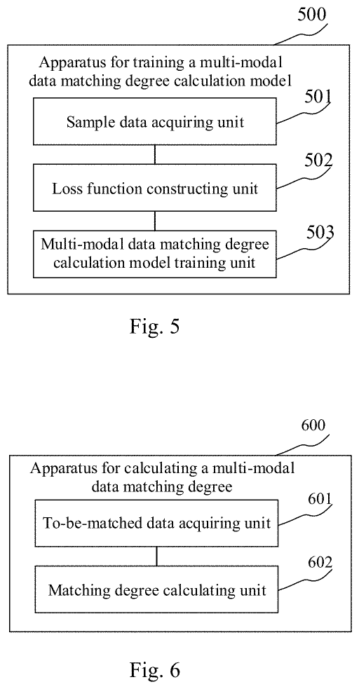

Further referring to FIGS. 5 and 6, as implementations of the methods shown in the above drawings, an embodiment of the present disclosure respectively provides an apparatus for training a multi-modal data matching degree calculation model and an embodiment of an apparatus for calculating a multi-modal data matching degree. The embodiment of the apparatus for training a multi-modal data matching degree calculation model corresponds to the embodiment of the method for training a multi-modal data matching degree calculation model shown in FIG. 2, and the embodiment of the apparatus for calculating a multi-modal data matching degree corresponds to the embodiment of the method for calculating a multi-modal data matching degree. The apparatuses may be applied in various electronic devices.

As shown in FIG. 5, the apparatus 500 for training a multi-modal data matching degree calculation model in this embodiment may include: a sample data acquiring unit 501, a loss function constructing unit 502 and a multi-modal data matching degree calculation model training unit 503. Here, the sample data acquiring unit 501 is configured to acquire first sample data and second sample data that are different in modalities. The loss function constructing unit 502 is configured to construct a contrastive learning loss function comprising a semantic perplexity parameter, the semantic perplexity parameter being determined based on a semantic feature distance between the first sample data and the second sample data. The multi-modal data matching degree calculation model training unit 503 is configured to train, by using the contrastive learning loss function, an initial multi-modal data matching degree calculation model through a contrastive learning approach, to obtain a target multi-modal data matching degree calculation model.

In this embodiment, for detailed processes of the sample data acquiring unit 501, the loss function constructing unit 502 and the multi-modal data matching degree calculation model training unit 503 in the apparatus 500 for training a multi-modal data matching degree calculation model, and their technical effects, reference may be respectively made to the related descriptions of steps 201-203 in the corresponding embodiment of FIG. 2, and thus, the details will not be repeatedly described here.

In some alternative implementations of this embodiment, the apparatus for training a multi-modal data matching degree calculation model further includes: a sample data batch acquiring unit, configured to acquire a plurality of pieces of first sample data and a plurality of pieces of second sample data; a memory bank storing unit, configured to store a semantic feature of each piece of first sample data into a first memory bank and store a semantic feature of each piece of second sample data into a second memory bank; a momentum update unit, configured to perform a momentum update on an encoder of the first memory bank and an encoder of the second memory bank respectively, and extract a first semantic feature from the first memory bank completing the momentum update, and extract a second semantic feature from the second memory bank completing the momentum update; and a semantic feature extracting unit, configured to determine the semantic perplexity parameter based on a semantic feature distance between the first semantic feature and the second semantic feature.

In some alternative implementations of this embodiment, the memory bank storing unit is further configured to: store at least two pieces of first sample data into the first memory bank in a form of a set, and store at least two pieces of second sample data into the second memory bank in a form of a set.

In some alternative implementations of this embodiment, the loss function constructing unit 502 includes: an initial loss function acquiring subunit, configured to acquire an initial contrastive learning loss function in the contrastive learning approach, the initial contrastive learning loss function being used to supervise model training; a semantic perplexity representing subunit, configured to represent the semantic perplexity parameter using a cosine relationship between a semantic feature of the first sample data and a semantic feature of the second sample data; and a contrastive learning loss function constructing subunit, configured to construct the contrastive learning loss function based on the initial contrastive learning loss function and the semantic perplexity parameter.

In some alternative implementations of this embodiment, the apparatus for training a multi-modal data matching degree calculation model further includes: a constraint imposing unit, configured to impose a constraint on at least one of items in the contrastive learning loss function, the items include: the first sample data, the second sample data, a semantic feature of the first sample data that is obtained based on the first memory bank, and a semantic feature of the second sample data that is obtained based on the second memory bank.

In some alternative implementations of this embodiment, the first sample data includes sample image data, and the second sample data includes sample text data.

This embodiment exists as an apparatus embodiment corresponding to the above method embodiment. According to the apparatus for training a multi-modal data matching degree calculation model provided in this embodiment, the semantic perplexity parameter, which is determined based on the semantic feature distance between the first sample data and the second sample data that are different in modalities, is added to the loss function which is constructed based on a conventional contrastive learning idea. The multi-modal data matching degree calculation model trained through the contrastive learning loss function is capable of adjusting the degree of attention to the calculation for a degree of matching between data of different modalities, according to the semantic perplexity of a multi-modal data pair that is used to calculate a degree of matching, to acquire the degree of matching between data of a plurality of modalities more accurately.

As shown in FIG. 6, the apparatus 600 for calculating a multi-modal data matching degree in this embodiment may include: a to-be-matched data acquiring unit 601 and a matching degree calculating unit 602. Here, the to-be-matched data acquiring unit 601 is configured to acquire a to-be-tested data pair composed of first data and second data that are different in modalities. The matching degree calculating unit 602 is configured to invoke a preset multi-modal data matching degree calculation model to process the to-be-tested data pair, to obtain a semantic matching degree of the to-be-tested data pair. Here, the multi-modal data matching degree calculation model is trained and obtained based on a contrastive learning loss function through a contrastive learning approach. The contrastive learning loss function includes a semantic perplexity parameter, and the semantic perplexity parameter is determined based on a semantic feature distance between first sample data and second sample data that are different in modalities.

In this embodiment, the detailed processes of the to-be-matched data acquiring unit 601 and the matching degree calculating unit 602 in the apparatus 600 for calculating a multi-modal data matching degree and their technical effects may respectively correspond to the related descriptions in the method embodiment, and thus will not be repeatedly described here.

This embodiment exists as an apparatus embodiment corresponding to the above method embodiment. According to the apparatus for calculating a multi-modal data matching degree provided in this embodiment, after the to-be-tested data pair composed of the first data and the second data that are different in modalities is acquired, the multi-modal data matching degree calculation model, which is trained and obtained using the contrastive learning loss function comprising the semantic perplexity parameter, is invoked to process the to-be-tested data pair, to obtain a matching degree between the first data and the second data that are included in the to-be-tested data pair. The multi-modal data matching degree calculation model may determine a corresponding matching degree calculation strategy and matching resource based on the semantic perplexity parameter between the first data and the second data. That is, the degree of matching between the first data and the second data is calculated by using the matching degree calculation strategy and the matching resource that match the semantic perplexity parameter, rather than through an approach of uniformly or fixedly allocating a calculation resource in the prior art. Thus, the matching degree calculation resources can be tilted toward the first data and the second data that have a high semantic perplexity, to further improve the accuracy of the calculation for the degree of matching.

According to an embodiment of the present disclosure, an electronic device is provided. The electronic device includes at least one processor, and a storage device in communication with the at least one processor. Here, the storage device stores instructions executable by the at least one processor, and the instructions are executed by the at least one processor, to enable the at least one processor to implement the method for training a multi-modal data matching degree calculation model and/or the method for calculating a multi-modal data matching degree described in any of the above embodiments.

According to an embodiment of the present disclosure, a readable storage medium is provided. The readable storage medium stores a computer instruction. Here, the computer instruction is used to cause a computer to implement the method for training a multi-modal data matching degree calculation model and/or the method for calculating a multi-modal data matching degree described in any of the above embodiments.

An embodiment of the present disclosure provides a computer program product. A computer program, when executed by a processor, can implement the method for training a multi-modal data matching degree calculation model and/or the method for calculating a multi-modal data matching degree described in any of the above embodiments.

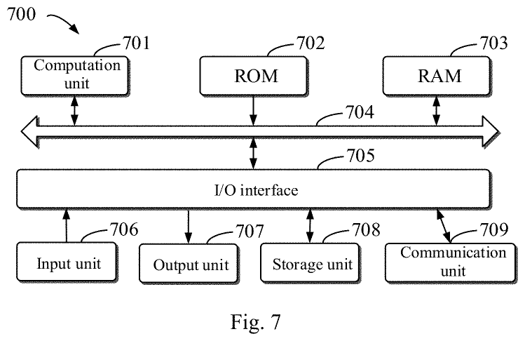

FIG. 7 is a schematic block diagram of an example electronic device 700 that may be used to implement embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 7, the device 700 includes a computation unit 701, which may perform various appropriate actions and processing, based on a computer program stored in a read-only memory (ROM) 702 or a computer program loaded from a storage unit 708 into a random access memory (RAM) 703. In the RAM 703, various programs and data required for the operation of the device 700 may also be stored. The computation unit 701, the ROM 702, and the RAM 703 are connected to each other through a bus 704. An input/output (I/O) interface 705 is also connected to the bus 704.

A plurality of parts in the device 700 are connected to the I/O interface 705, including: an input unit 706, for example, a keyboard and a mouse; an output unit 707, for example, various types of displays and speakers; the storage unit 708, for example, a disk and an optical disk; and a communication unit 709, for example, a network card, a modem, or a wireless communication transceiver. The communication unit 709 allows the device 700 to exchange information/data with other devices over a computer network such as the Internet and/or various telecommunication networks.

The computation unit 701 may be various general-purpose and/or dedicated processing components having processing and computing capabilities. Some examples of the computation unit 701 include, but are not limited to, central processing unit (CPU), graphics processing unit (GPU), various dedicated artificial intelligence (AI) computing chips, various computation units running machine learning model algorithms, digital signal processors (DSP), and any appropriate processors, controllers, microcontrollers, etc. The computation unit 701 performs the various methods and processes described above, such as a method for training a multi-modal data matching degree calculation model and/or a method for calculating a multi-modal data matching degree. For example, in some embodiments, the method for training a multi-modal data matching degree calculation model and/or the method for calculating a multi-modal data matching degree may be implemented as a computer software program, which is tangibly included in a machine readable medium, such as the storage unit 708. In some embodiments, part or all of the computer program may be loaded and/or installed on the device 700 via the ROM 702 and/or the communication unit 709. When the computer program is loaded into the RAM 703 and executed by the computation unit 701, one or more steps of the method for training a multi-modal data matching degree calculation model and/or the method for calculating a multi-modal data matching degree described above may be performed. Alternatively, in other embodiments, the computation unit 601 may be configured to perform the method for training a multi-modal data matching degree calculation model and/or the method for calculating a multi-modal data matching degree by any other appropriate means (for example, by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a cloud server, also known as a cloud computing server or a cloud host. It is a host product in the cloud computing service system to solve the defects of the traditional physical host and virtual private server (VPS) services, such as high management difficulty and weak business scalability.

In the technical solution of embodiments of the present disclosure, according to the method for training a multi-modal data matching degree calculation model, a semantic perplexity parameter, which is determined based on a semantic feature distance between first sample data and second sample data that are different in modalities, is added to a loss function constructed based on a conventional contrastive learning idea. The multi-modal data matching degree calculation model trained through the contrastive learning loss function can adjust the degree of attention to the calculation for a degree of matching between data of different modalities according to the semantic perplexity of a multi-modal data pair that is used to calculate a degree of matching, to acquire the degree of matching between data of a plurality of modalities more accurately.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for training a multi-modal data matching degree calculation model, comprising:
acquiring first sample data and second sample data that are different in modalities;
constructing a contrastive learning loss function comprising a semantic perplexity parameter, the semantic perplexity parameter being determined based on a semantic feature distance between the first sample data and the second sample data; and
training, by using the contrastive learning loss function, an initial multi-modal data matching degree calculation model through a contrastive learning approach, to obtain a target multi-modal data matching degree calculation model.

2. The method according to claim 1, further comprising:
acquiring a plurality of pieces of the first sample data and a plurality of pieces of the second sample data;
storing a semantic feature of each piece of the first sample data into a first memory bank and storing a semantic feature of each piece of the second sample data into a second memory bank;
performing a momentum update on an encoder of the first memory bank and an encoder of the second memory bank respectively, and extracting a first semantic feature from the first memory bank completing the momentum update, and extracting a second semantic feature from the second memory bank completing the momentum update; and
determining the semantic perplexity parameter based on a semantic feature distance between the first semantic feature and the second semantic feature.

3. The method according to claim 2, wherein storing the semantic feature of each piece of the first sample data into a first memory bank and storing the semantic feature of each piece of the second sample data into a second memory bank comprises:
storing at least two pieces of the first sample data into the first memory bank in a form of a set, and storing at least two pieces of the second sample data into the second memory bank in a form of a set.

4. The method according to claim 1, wherein constructing the contrastive learning loss function comprising the semantic perplexity parameter comprises:
acquiring an initial contrastive learning loss function in the contrastive learning approach, the initial contrastive learning loss function being used to supervise model training;
representing the semantic perplexity parameter with a cosine relationship between a semantic feature of the first sample data and a semantic feature of the second sample data; and
constructing the contrastive learning loss function based on the initial contrastive learning loss function and the semantic perplexity parameter.

5. The method according to claim 2, further comprising imposing a constraint on at least one of items in the contrastive learning loss function, the items include:
the first sample data, the second sample data, a semantic feature of the first sample data that is obtained based on the first memory bank, and a semantic feature of the second sample data that is obtained based on the second memory bank.

6. The method according to claim 1, wherein the first sample data comprises sample image data, and the second sample data comprises sample text data.

7. The method according to claim 1, wherein the method further comprises calculating a multi-modal data matching degree, comprising:
acquiring a to-be-tested data pair composed of first data and second data that are different in modalities;
invoking the target multi-modal data matching degree calculation model to process the to-be-tested data pair and to obtain a semantic matching degree of the to-be-tested data pair.

8. The method according to claim 7, wherein the first data comprises image data, and the second data comprises text data.

9. An apparatus for training a multi-modal data matching degree calculation model, comprising:
at least one processor; and
a memory that stores instructions which, when executed by the at least one processor, cause the at least one processor to perform operations comprising:
acquiring first sample data and second sample data that are different in modalities;
constructing a contrastive learning loss function comprising a semantic perplexity parameter, the semantic perplexity parameter being determined based on a semantic feature distance between the first sample data and the second sample data; and
training, by using the contrastive learning loss function, an initial multi-modal data matching degree calculation model through a contrastive learning approach, to obtain a target multi-modal data matching degree calculation model.

10. The apparatus according to claim 9, wherein the operations further comprise:
acquiring a plurality of pieces of the first sample data and a plurality of pieces of the second sample data;
storing a semantic feature of each piece of the first sample data into a first memory bank and storing a semantic feature of each piece of the second sample data into a second memory bank;
performing a momentum update on an encoder of the first memory bank and an encoder of the second memory bank respectively, and extracting a first semantic feature from the first memory bank completing the momentum update, and extracting a second semantic feature from the second memory bank completing the momentum update; and
determining the semantic perplexity parameter based on a semantic feature distance between the first semantic feature and the second semantic feature.

11. The apparatus according to claim 10, wherein storing a semantic feature of each piece of the first sample data into a first memory bank and storing a semantic feature of each piece of the second sample data into a second memory bank comprises: storing at least two pieces of the first sample data into the first memory bank in a form of a set, and storing at least two pieces of the second sample data into the second memory bank in a form of a set.

12. The apparatus according to claim 9, wherein constructing the contrastive learning loss function comprising the semantic perplexity parameter comprises:
acquiring an initial contrastive learning loss function in the contrastive learning approach, the initial contrastive learning loss function being used to supervise model training;
representing the semantic perplexity parameter using a cosine relationship between a semantic feature of the first sample data and a semantic feature of the second sample data; and
constructing the contrastive learning loss function based on the initial contrastive learning loss function and the semantic perplexity parameter.

13. The apparatus according to claim 10, further comprising:
imposing a constraint on at least one of items in the contrastive learning loss function, the items include:
the first sample data, the second sample data, the semantic feature of the first sample data that is obtained based on the first memory bank, and the semantic feature of the second sample data that is obtained based on the second memory bank.

14. The apparatus according to claim 9, wherein the first sample data comprises sample image data, and the second sample data comprises sample text data.

15. The apparatus according to claim 9, wherein the operations further comprise calculating a multi-modal data matching degree, comprising:
acquiring a to-be-tested data pair composed of first data and second data that are different in modalities;
invoking the target multi-modal data matching degree calculation model to process the to-be-tested data pair and to obtain a semantic matching degree of the to-be-tested data pair.

16. The apparatus according to claim 15, wherein the first data comprises image data, and the second data comprises text data.

17. A non-transitory computer readable storage medium, storing computer instructions which, when executed by a computer, cause the computer to perform operations, the operations comprising:
acquiring first sample data and second sample data that are different in modalities;
constructing a contrastive learning loss function comprising a semantic perplexity parameter, the semantic perplexity parameter being determined based on a semantic feature distance between the first sample data and the second sample data; and
training, by using the contrastive learning loss function, an initial multi-modal data matching degree calculation model through a contrastive learning approach, to obtain a target multi-modal data matching degree calculation model.

18. The non-transitory computer readable storage medium according to claim 17, wherein the operations further comprise:
acquiring a plurality of pieces of the first sample data and a plurality of pieces of the second sample data;
storing a semantic feature of each piece of the first sample data into a first memory bank and storing a semantic feature of each piece of the second sample data into a second memory bank;
performing a momentum update on an encoder of the first memory bank and an encoder of the second memory bank respectively, and extracting a first semantic feature from the first memory bank completing the momentum update, and extracting a second semantic feature from the second memory bank completing the momentum update; and
determining the semantic perplexity parameter based on a semantic feature distance between the first semantic feature and the second semantic feature.

19. The non-transitory computer readable storage medium according to claim 18, wherein storing a semantic feature of each piece of the first sample data into a first memory bank and storing a semantic feature of each piece of the second sample data into a second memory bank comprises:
storing at least two pieces of the first sample data into the first memory bank in a form of a set, and storing at least two pieces of the second sample data into the second memory bank in a form of a set.

20. The non-transitory computer readable storage medium according to claim 17, wherein constructing the contrastive learning loss function comprising the semantic perplexity parameter comprises:
acquiring an initial contrastive learning loss function in the contrastive learning approach, the initial contrastive learning loss function being used to supervise model training;
representing the semantic perplexity parameter with a cosine relationship between a semantic feature of the first sample data and a semantic feature of the second sample data; and
constructing the contrastive learning loss function based on the initial contrastive learning loss function and the semantic perplexity parameter.
